(19) United States
(12) Patent Application Publication
(10) Pub. No.: US 2009/0067518 A1
(43) Pub. Date: Mar. 12, 2009

(54) Interpolation Method and a Related Device for Channel Estimation in Communication Systems

(76) Inventors: Bruno Melis, Torino (IT); Alfredo Ruscitto, Torino (IT); Rosalba Campanale, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/087,098

(22) PCT Filed: Dec. 28, 2005
(86) PCT No.: PCT/EP2005/014066

§ 371 Date: Jul. 23, 2008

(51) Int. Cl. H04L 25/02

(52) U.S. Cl. 375/260

(57) ABSTRACT

A method for interpolating between a first and a second point includes the steps of calculating a first distance between a first and a second independent value and a second distance between a first and a second dependent value, right shifting the first and the second distances by a predetermined number of bits for obtaining respectively a hold step and a variations step and generating a number of interpolated points, having independent values between the first and the second independent values and corresponding dependent values obtained by alternating hold and variations phases, wherein the hold phase consists of generating a number of points corresponding to the hold step having the same dependent value, and wherein the variations phase consists of varying the dependent value by the variations step until the number of interpolated points has been calculated. The method is particularly suitable for channel estimation in communication systems.

### TECHNICAL FIELD

The present invention relates to an interpolator. More particularly, the present invention relates to an interpolation method and to the related device that is cost-effectively implemented in hardware using digital circuits of minimal complexity.

The method according to the invention is particularly suitable for the interpolation of fixed point signals, namely sampled signals whose values are represented using finite precision arithmetic.

### BACKGROUND ART

Interpolation techniques are used in a number of technical fields. For example, interpolation techniques are used in digital receivers for channel estimation purposes. In fact, in many wireless or wired transmission systems the channel estimation is performed by means of training sequences, known to the receiver, that are multiplexed with the user data.

Training sequences are typically transmitted only in a part of the transmission frame. The remaining part of the frame is used for the transmission of user data or control information so that it is not possible to estimate the channel characteristics continuously over the whole frame. In order to estimate the channel characteristics in the parts of the frame where the user or control data are transmitted, some kind of interpolation is required.

In the following, as an example of technical application of an interpolation technique, reference is made to an interpolation method for the channel estimation in wireless communication systems that exploit multi-carrier transmission using the OFDM (Orthogonal Frequency Division Multiplexing) technique and multiple transmit/receive antennas (e.g. MIMO or Multiple Input Multiple Output). MIMO refers to the adoption of multiple antennas at both the transmitter and the receiver in order to create multiple spatial channels. These multiple spatial channels are used in parallel to transmit independent data streams and thus increase the transmission data rate or throughput.

OFDM is a modulation technique that distributes the data over a large number of subcarriers that are spaced apart at precise frequencies. The subcarrier frequency spacing is selected so that each subcarrier is orthogonal with respect to the others. In particular, orthogonality is achieved by selecting the subcarrier frequency spacing equal to the reciprocal of the useful symbol period. The benefits of OFDM are high spectral efficiency, resiliency to RF interference and multi-path propagation. OFDM is chosen over a single-carrier solution due to its lower complexity compared to time domain equalizers for high delay spread channels or high data rate systems. The OFDM modulation/demodulation can be efficiently implemented in the digital domain by using Fast Fourier Transforms (FFTs) at both the transmitter and the receiver.

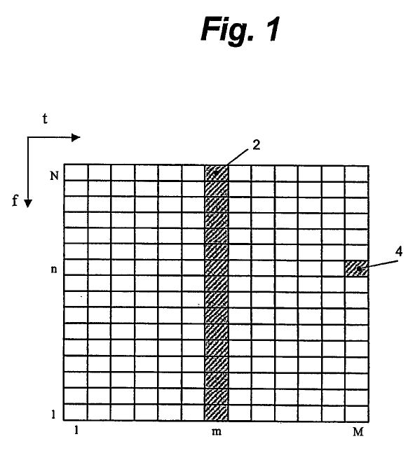

In an OFDM system, the channel estimation is usually performed by sending training (or pilot) symbols on subcarriers known at the receiver. The insertion of the pilot sub-carriers can be described considering a two dimensional (2D) time-frequency grid, as shown in FIG. 1. The time axis t is numbered with the indexes of the transmitted OFDM symbols, while the frequency axis f is numbered with the indexes of the OFDM subcarriers transmitted within each OFDM symbol. Reference number 2 indicates the m-th OFDM symbol and reference number 4 indicates the n-th sub-carrier.

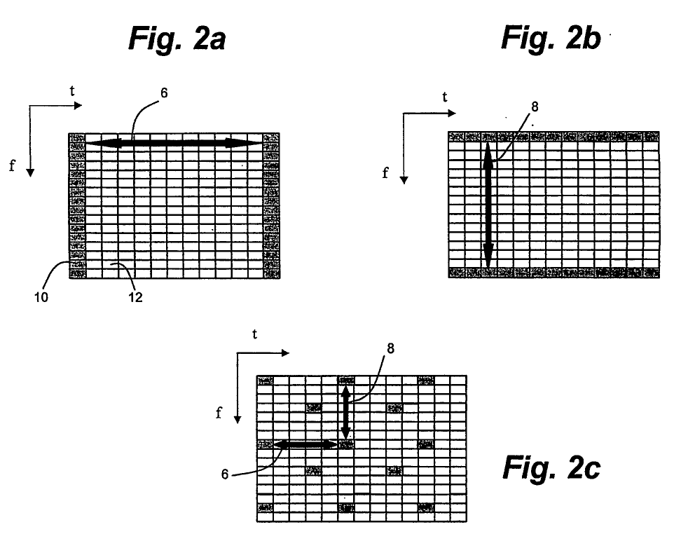

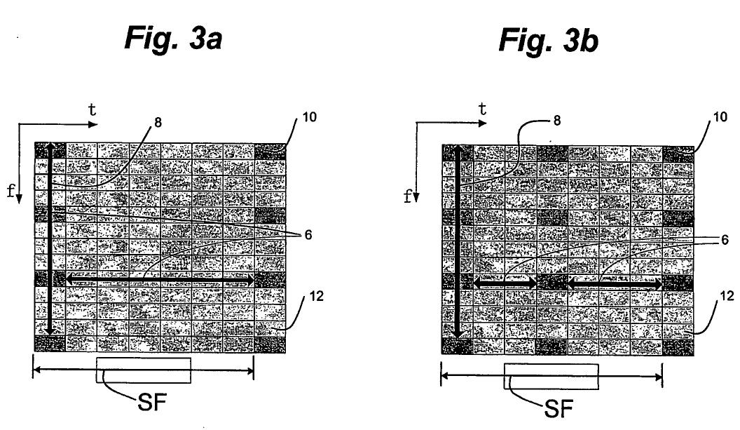

The pilot symbols are overhead, and should be as few in number as possible in order to maximize the transmission rate of data symbols. Since the channel response can vary with time and with frequency, the pilot symbols can be scattered amongst the data symbols in order to provide a reliable estimation of the channel response over time and frequency. The set of subcarrier frequencies and OFDM symbols at which pilot symbols are inserted is referred to as a pilot pattern. With reference to FIGS. 2a-2c and 3a-3b, pilot symbols 10 are represented by grey rectangular boxes while data symbols 12 are represented by white rectangular boxes.

The pilot pattern can be inserted in various ways: for example, pilot symbols 10 can be distributed in the frequency domain by using part of or all the subcarriers of an OFDM symbol. Such a pilot pattern, denoted as TDM (Time Division Multiplexing) pattern and an example of which is represented in FIG. 2a, requires an interpolation 6 in the time domain over consecutive OFDM symbols carrying pilots, in order to estimate the channel characteristics.

A complementary pattern, denoted as FDM (Frequency Division Multiplexing) pattern and an example of which is represented in FIG. 2b, is obtained by using the same subcarrier of each OFDM symbol to carry pilots 10. In this case an interpolation 8 in the frequency domain is required to accomplish the channel estimation. A third pattern, denoted as scattered pattern and represented in FIG. 2c, uses both the TDM and the FDM patterns to distribute pilot symbols 10 over the time-frequency grid. In this case, an interpolation 6 in time domain and an interpolation 8 in frequency domain are required for the estimation of the channel characteristics in correspondence with the data symbols 12.

In order to make a practical example of application of the interpolation method according to the invention, it is considered in the following a radio transmission scheme that is currently under study for the Long Term Evolution (LTE) of the UMTS Terrestrial Radio Access (UTRA). Said radio transmission scheme is described in detail in the technical report “3GPP TR 25.814”, in November 2005 (V 1.0.1, release 7) and available at the Internet website http://www.3gpp.org. It is clear that this is only one possible example of application of the invention and that other examples may be conceived.

The evolution of the UTRA radio interface, denoted with the acronym E-UTRA and also known as Super-3G system, is going to be designed to support mobile speeds of up to 120 km/h. In addition, the E-UTRA must be able to support higher user speeds of up to 350 km/h with reduced performance. The OFDM technique is one of the multiple access techniques considered for the application in downlink of E-UTRA. The downlink transmission scheme is based on conventional OFDM using a cyclic prefix, with a sub-carrier spacing Δf=15 kHz and a cyclic-prefix (CP) duration T_{CP}=4.7/16.7 μs (short/long CP).

The E-UTRA air interface supports both frequency division duplex (FDD) and time division duplex (TDD) modes of operation. The sub-carrier spacing Δf is constant, regardless of the transmission bandwidth. To allow for operation in differently sized spectrum allocations, the transmission bandwidth is instead varied by changing the number of OFDM sub-carriers. The transmission bandwidth can be equal to 1.25, 2.5, 5, 10, 15, and 20 MHz, to which corresponds a number of OFDM occupied subcarriers equal to 76, 151, 301, 601, 901 and 1201 respectively.

The radio frame has a time duration of 10 ms and is divided into 20 equally sized sub-frames, which implies a sub-frame duration T_{sub-frame}=0.5 ms. Each sub-frame is composed by 7 or 6 OFDM symbols, depending on the used CP duration (short/long CP).

In each sub-frame is inserted a suitable number of pilot symbols that can be used for downlink channel estimation, downlink channel quality measurement, cell search and initial acquisition. The use of an adjustable pilot density in order to adapt to different channel properties (time/frequency selectivity) is also under study.

Basically, two pilot patterns are analyzed: TDM pilot pattern and scattered pilot pattern. An example of the TDM pilot pattern structure is shown in FIG. 3a in which pilot symbols 10 are carried only in the first symbol of every sub-frame SF. The TDM pilot format has some advantages over the scattered format, which include low user equipment power consumption, faster user equipment synchronization (cell search) and lower latency in decoding the control channel. Lower power consumption in the user equipment and lower decoding latency by using the TDM pilot pattern, is expected when the control channel is multiplexed with the pilot subcarriers in the first OFDM symbol of the sub-frame SF. In this case, the user equipment decodes the resource allocation information and goes to the power saving mode, if no data are allocated to it in the current sub-frame. A drawback of the TDM pattern is that it shows relevant performance degradation for high user speeds in the order of 350 km/h.

An example of the scattered pilot pattern for E-UTRA is shown in FIG. 3b, which allows two OFDM symbols in each sub-frame SF to carry pilot sequences. The scattered pilot pattern structure provides reasonable performance even at very high user speeds in the order of 350 km/h, and can be thus conditionally used for user equipments moving at very high speed.

The TDM and scattered pilot patterns, respectively shown in FIGS. 3a and 3b, are exemplary configurations. In general multiple pilot patterns, characterized by different pilot densities, will be used, in order to adapt the system characteristics to the different channel properties (time/frequency selectivity).

The E-UTRA radio interface is also intended to support multiple transmit/receive antennas. The baseline antenna configuration for MIMO is two transmit antennas at the cell site and two receive antennas at the user equipment. The possibility for higher-order downlink MIMO (more than two TX/RX antennas) is also under study. In order to support advanced antenna solutions such as MIMO, beam-forming and so on, multiple orthogonal pilot patterns are required to distinguish at the user. equipment receiver the different TX antennas, the different beams, etc. In such a case the computation of the channel coefficients becomes even more complex, thus requiring very fast and flexible interpolation circuits.

Given a certain pilot pattern, the estimation of the channel response in correspondence of the data symbols is performed by interpolation in the frequency and time domain. Considering that a wireless communication system, such the E-UTRA system, based on MIMO and OFDM is expected to provide high throughputs in the order of hundred of Mbit/s, and that the number of interpolated values varies as a function of the selected pilot pattern, it becomes important to define a flexible interpolation method which can be implemented with a simple and fast hardware circuit.

In general, linear interpolation is a mathematical operation for estimating values that lie between two known values or points. Given two known points A and B with cartesian coordinates A=(x_{A},y_{A}) and B=(x_{B},y_{B}), the ordinate y_{P} of an interpolated point with abscissa x_{P} is calculated with the well known formula for the linear interpolation:

$${y}_{P} = {y}_{A} + \frac{{y}_{B} - {y}_{A}}{{x}_{B} - {x}_{A}} \cdot ( {x}_{P} - {x}_{A} ) \qquad ( 1 )$$

The application of the equation (1) requires the execution of one multiplication and one division for each interpolated point and thus, due to the complexity of these operations from a circuital point of view, some form of simplification or approximation of the equation (1) is normally derived. The exact application of the equation (1) makes not feasible the implementation of a digital interpolation unit based on conventional logic circuitry, like the logic elements available in programmable logic devices (e.g. FPGA). In fact, the equation (1) requires the execution of floating point operations that can be only performed by a Digital Signal Processor (DSP), which often includes a floating point unit. However, the DSP approach has several drawbacks such as the bottleneck represented by the data transfer to the DSP and the high computation time of the interpolated values. On the other hand, the floating point computation ensures the maximum precision in the calculation of the interpolated values.

Interpolation methods are known in the art.

U.S. Pat. No. 5,886,911 describes a fast calculation method and its hardware apparatus for the linear interpolation. The linear interpolation method adopts a concept of a bisection method The position where the target point I is located is gradually approached by dividing the interval between the two known points X and Y in a number of segments equal to 2″ (i.e. a power of two).

U.S. Patent Application No. 2002/0152248 describes the implementation of a linear interpolator that is based on a multi-bit approach. The interpolation circuit proposed uses multi-bit values to eliminate the use of multipliers, making use of multiplexers and bit shift operations.

### OBJECT AND SUMMARY OF THE INVENTION

The Applicant has observed that the interpolation methods proposed in the art are not completely satisfactory.

For example, in respect of U.S. Pat. No. 5,886,911, the Applicant has observed that the number of interpolated points is not selectable by the user, but is constrained to take only certain values which are equal to 2ⁿ−1 where n is an integer number.

In respect of U.S. Patent Application No. 2002/0152248, the Applicant has remarked that the number of interpolated points is a fixed parameter that must be defined before the logical synthesis of the interpolation circuit.

The interpolation methods described in U.S. Pat. No. 5,886,911 and in U.S. Patent Application No. 2002/0152248 are therefore not suitable for channel estimation in communication systems, since in such an estimation the number of interpolated points should be dynamically varied in accordance with the selected pilot pattern.

The Applicant has tackled the problem of providing an interpolation method which can be cost-effectively implemented in hardware and which allows to vary flexibly the number of interpolated points without requiring any modification in the device implementing such a method.

It is therefore a first object of the present invention to provide a linear interpolation method wherein the number of interpolated points can be varied at any time without any effort.

According to the invention, the number of interpolated values is a run time parameter of the circuit and therefore, when for instance estimating channels in communication systems, it can be adapted to the selected pilot pattern, to the number of OFDM sub-carriers and in general to the propagation channel characteristics.

It is a second object of the present invention to provide a very simple and fast interpolation circuit that can be implemented with conventional logic circuitry, such as the basic logic elements that are available in programmable logic devices (e.g. FPGA).

The method according to the invention is particularly suitable to be used for estimating channels in communication systems, as it can be implemented with a limited number of logic gates using fast logic programmable devices, such as FPGA.

Moreover, the method according to the invention is particularly suitable for applications where it is required an interpolation between two values with a very short computation time.

It is a third object of the present invention to provide an interpolation method that can be cost-effectively implemented in hardware.

According to the invention, the function interpolating between two known values is a function formed by a plurality of contiguous steps, wherein the width and the height of the steps are calculated by shifting right by a predetermined number of bits the values of the distances on the abscissa and ordinate axis of the two known points. The predetermined number of bits depends on a resolution parameter representing the resolution according to which the width and the height of the steps are represented.

The method according to the invention further allows to define the resolution according to which the interpolated points are generated.

The method according to the invention is particularly suitable for channel estimation in communication systems, but it can also be more generally applied to a sampled signal, wherein the independent values represent a discrete spatial, time or frequency index and the dependent variables represent values of the sampled signal.

The device for implementing the method according to the invention comprises a limited number of logic gates which perform very simple operations, like for instance additions and right shifting.

Further features and advantages of the present invention will be made clearer by the following detailed description of some examples thereof, provided purely by way of example and without restrictive intent.

The detailed description will refer to the following Figures, wherein:

FIG. 1 shows a two dimensional time-frequency grid representing a plurality of pilot sub-carriers useful for estimating a channel in an OFDM communication system;

FIGS. 2a, 2b and 2c respectively show an example of a TDM (Time Division Multiplexing) pilot pattern, of a FDM (Frequency Division Multiplexing) pilot pattern and of a scattered pilot pattern;

FIGS. 3a and 3b respectively show an example of a TDM pilot pattern and of a scattered pattern in a sub-frame of an E-UTRA communication system;

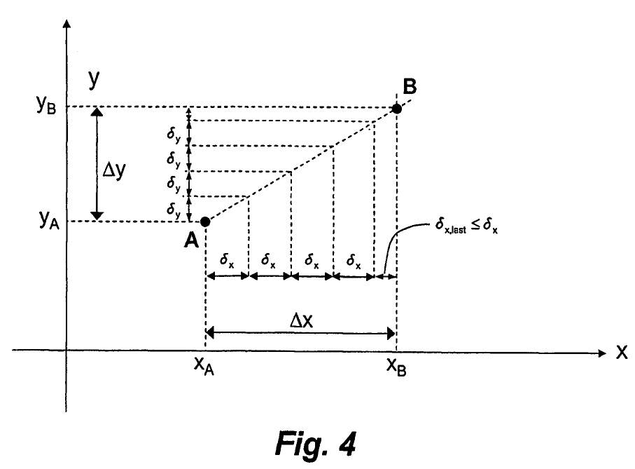

FIG. 4 represents a step of the method according to the invention, showing in particular the sub-intervals between the interpolated values;

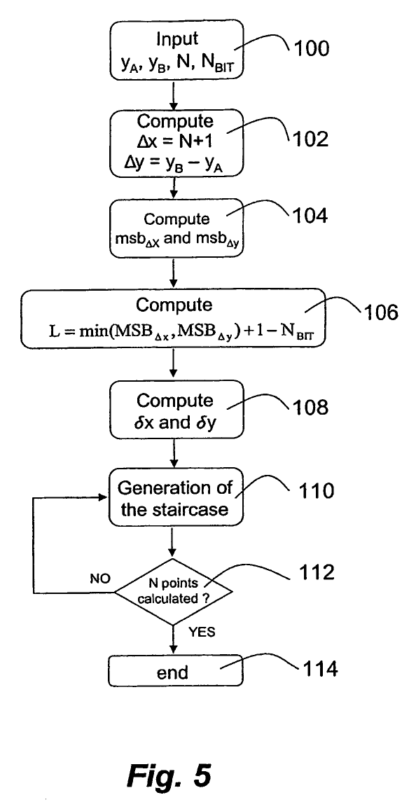

FIG. 5 show a flow chart of the interpolation method according to the invention;

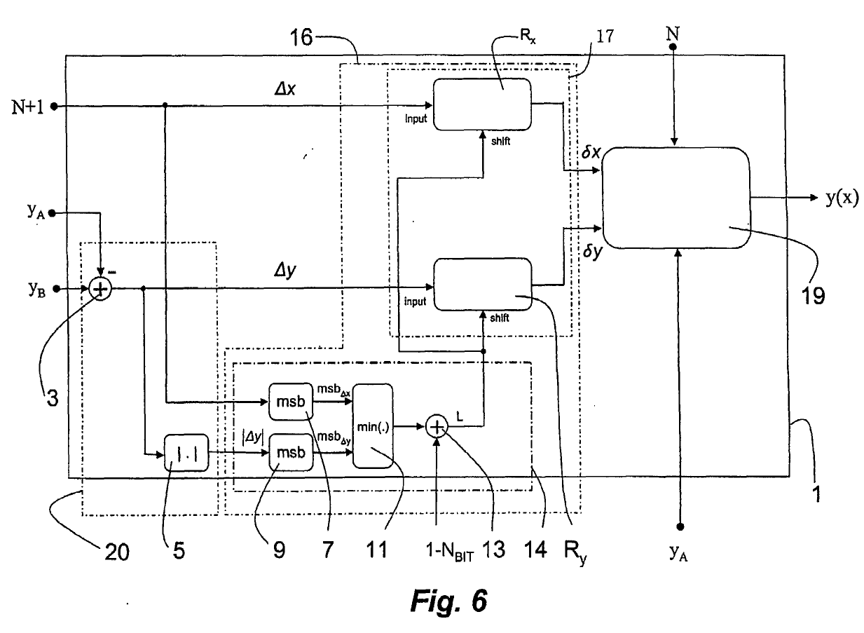

FIG. 6 show a block diagram of an interpolating device for implementing the interpolation method of FIG. 5;

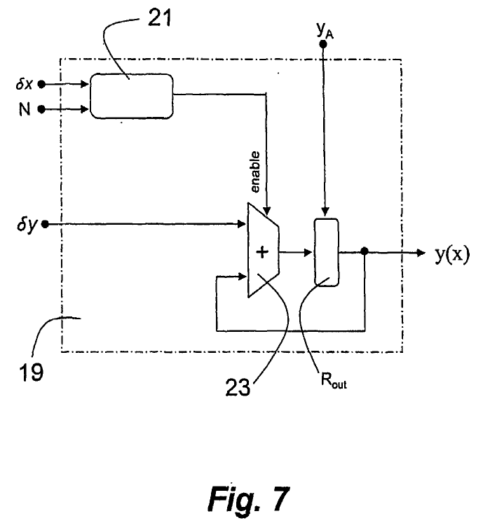

FIG. 7 show a block diagram of an interpolation function generator;

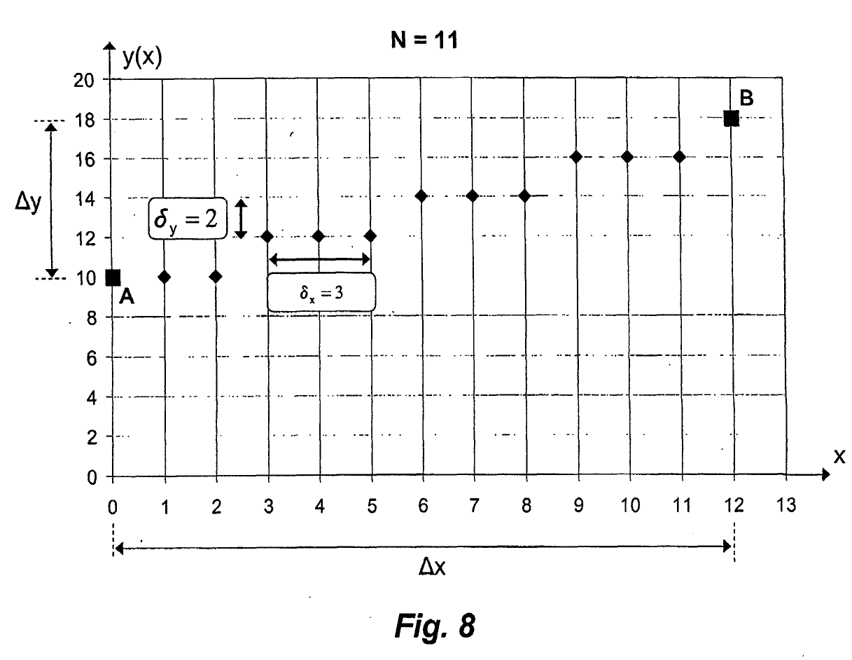

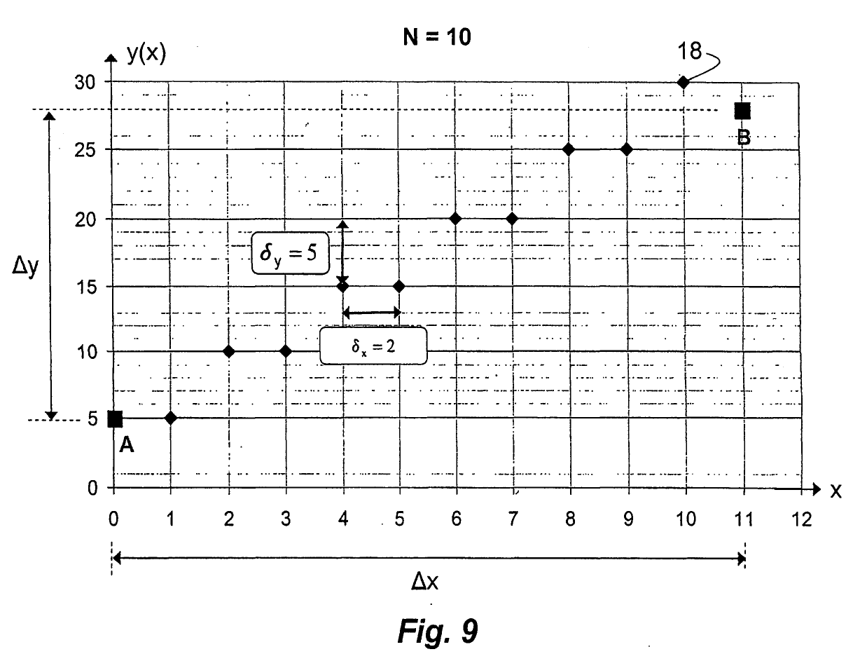

FIGS. 8 and 9 show graphical examples of an interpolation function between two known points in accordance with the method of the present invention

### BEST MODE FOR CARRYING OUT THE INVENTION

In the method according to the invention, it is considered the interpolation between two known points A and B with cartesian co-ordinates A=(x_{A},y_{A}) and B=(x_{B},y_{B}) respectively. The values x_{A}, x_{B}, y_{A}, y_{B} are fixed point numbers, represented using a two's complement notation. The abscissas of the two known points represent the independent variable of the function that must be interpolated. The ordinates of the two known points represent the value of such function. For example in case of a sampled signal, the abscissa represents the discrete time index while the ordinate represents the value of the signal (e.g. the voltage) quantized over a suitable number of bits. More in particular, the abscissa may represents a discrete time or frequency index and the ordinate a transmission channel coefficient of a communication system.

The method according to the invention and the related interpolation device 1, shown in FIG. 6, allow the calculation of N interpolated values between two known points A and B. The input parameter N is an integer positive number greater or equal than one (i.e. N≧1). The abscissas of the two known points A and B are the independent variables so that, given the value of N, the following relation holds:

Δx=x_{B}−x_{A}=N+1 (2)

As it will be clarified in the following, the value of N is an input parameter that can be varied depending on the desired resolution that is required in the interpolation process. The parameter N can be advantageously varied run-time without any change in the proposed interpolation method and device.

The first step of the proposed method consists in the calculation of the difference between the abscissas and the ordinates of the two known points A and B. By denoting these differences with Δx and Δy respectively and taking into account the relation (2), it is possible to write:

Δx=x_{B}−x_{A}=N+1 (3)

Δy=y_{B}−y_{A} (4)

The values of Δx and Δy are stored in two shift registers indicated with Rₓand R_{y} respectively. The basic idea behind the proposed method consists in dividing the interval Δx and the interval Δy in a certain number K of sub-intervals. In the general case one of these sub-intervals has on the abscissa a shorter length with respect to the other K−1 sub-intervals. An example of division of the two segments Δx and Δy in sub-intervals is shown in FIG. 4, for the case K=5.

As shown in FIG. 4, the length of the first K−1 sub-intervals is denoted with δₓ and δ_{y} for the abscissa and ordinate respectively. The last sub-interval on the left of the known point B may have a shorter length equal to δ_{x,last}≦δₓ.

The lengths δₓ and δ_{y} of the sub-intervals shown in FIG. 4 is calculated by dividing the two differences Δx and Δy by a proper number M=2^{L} that is a power of two. This operation is easily accomplished in hardware by executing a right-shift operation of L positions of the two differences Δx and Δy, respectively stored in the shift registers R_{X} and R_{Y}. By using a C code notation, the operation can be expressed as follows

δx=Δx>>L (5)

δy=Δy>>L (6)

where the operator >> represents the right shift operation.

It can be noticed that the ratio m=Δy/Δx is the angular coefficient of the straight line that joins the two known points A and B. The ratio \tilde{m}=δy/δx between the two values obtained after the right shift operation provides an approximation of the angular coefficient. This approximation derives from the numerical truncation of the two values Δy and Δx when performing the right shift operation. The numerical truncation does not occur only when the two values Δy and Δx, expressed in binary notation, have both L zeros in the LSB (Least Significant Bit) positions. In such a particular case the values of m=Δy/Δx and \tilde{m}=δy/δx are equal and there is no approximation of the angular coefficient.

The value of L is chosen in order to have a non zero value for the sub-interval lengths δₓ and δ_{y}. Imposing the condition that the smaller between δₓ and δ_{y} must be represented with a minimum resolution of N_{BIT} bits, the value of L can be calculated as follows:

L=min(MSB_{Δx},MSB_{Δy})+1−N_{BIT} (7)

where the function min(.) takes the minimum of the two arguments, and MSB_{Δx}, MSB_{Δy} denote the most significant bit position of Δx (which is always a positive number) and of the absolute value of Δy respectively:

Δx→MSB_{Δx} |Δy|→MSB_{Δy} (8)

If the value calculated with the equation (7) is zero or negative, it means that no right shift has to be performed because one of the two values Δx or Δy is already represented with a number of bits equal or smaller than N_{BIT}. A typical value of the parameter N_{BIT}, that the simulations show to be optimal for the precision of the interpolation process, is an integer number between 2 and 4.

The last step of the interpolation algorithm is the generation of the ordinates of the interpolated points. The ordinates of the interpolated points are generated according to an interpolation function where the ordinate is kept constant for a certain number of points (hold phase) and then varied (variational phase). In particular, the ordinate of the interpolated points is kept constant for a group of δx consecutive points (hold step) and then varied of δy (variational step). Thus, the first set of δx points, including the known point A, has a constant ordinate equal to y_{A}. The second set of δx consecutive points has an ordinate equal to y_{A}+δy, the third set of δx consecutive points has an ordinate equal to y_{A}+2·δy and so on. The generation of the interpolation function is repeated until N interpolated points are calculated. In other words, a hold phase and a variational phase, or vice versa, are alternated until all N interpolated points have been calculated. The variational step δy may be an incremental step or a decremental step, depending on the ordinates y_{A},y_{B} of the points A,B to be interpolated.

The output signal y(x) of the interpolator can then be expressed with the following formula

$$y ( x ) = {y}_{A} + δ y ⌊ \frac{x}{δ x} ⌋ \qquad ( 9 )$$

where 1≦x≦N is the index of the interpolated point. In particular x=1 for the first interpolated on the right of the known point A and x=N for the last interpolated point that precedes the known point B. The mathematical operator └.┘ in the equation (9) provides the integer number less or equal than the argument

As an alternative embodiment, the first set of δx points may not include the known point A, and have an ordinate equal to y_{A}+C, where C is a constant which can be positive or negative. Consequently the second set of δx consecutive points has an ordinate equal to y_{A}+C+δy, and so on.

The flow chart of the proposed interpolation method is given in FIG. 5. In particular, the algorithm can be divided in four main steps:
Step 1: calculation of the differences Δx and Δy.
Step 2: calculation of L.
Step 3: calculation of the hold step δₓ and of the variational step δ_{y}.
Step 4: generation of the interpolation function that joins the two known points A and B.

More in particular, at step 100 the algorithm requires to input as data the Cartesian ordinates of two known points A e B, that is to say y_{A} and y_{B}. Moreover, there are further required the parameter N_{BIT}, which represents the resolution according to which the smaller between δₓ and δ_{y} must be represented and the parameter N which represents the number of desired interpolated values.

At step 102, the differences Δx and Δy are computed according to the formulae (3) and (4).

At step 104, the most significant bit (MSB) position of the values representing Δx and Δy is calculated.

At step 106, the parameter L representing the numbers of positions according to which the two values Δx and Δy must be right-shifted according to formula (7) is computed.

At step 108, the lengths of the hold step δₓ and of the variational step δ_{y} are calculated according to right-shift operations (5) and (6).

At step 110, interpolated values are computed according to formula (9). Such a computation is repeated (step 112) until N interpolated points have been calculated; when the last point has been calculated, the procedure stops (step 114). This may happen during a hold phase.

With reference to FIG. 6, it will now be described an interpolating device 1 for implementing the method according to the invention.

The interpolating device 1 receives as input the parameters y_{A}, y_{B} and N+1, which corresponds to the difference Δx, and provides as output the interpolation function y(x) which allows to calculate the N interpolated values between two known points A and B.

The interpolating device 1 comprises:
a first module 20 for calculating the distance Δy between the first y_{A} and the second y_{B} dependent values;
a second module 16 for right shifting the first Δx and the second Δy distances by a predetermined number of bits L for obtaining respectively a hold step δx and a variational step δy; and
a function generator 19 for generating the N interpolated values.

The second module 16 comprises, in turn, a first sub-module 14 for calculating the predetermined number of bits L and a second sub-module 17 for right shifting the distances Δx and Δy by said predetermined number of bits L.

The first module 20 comprises a subtractor 3 for calculating the difference Δy between y_{B} and y_{A} and a first block 5, which calculates the absolute value of said difference Δy.

The first sub-module 14 of the second module 16 comprises a second block 7 and a third block 9, which respectively calculate the most significant bit positions of N+1 and |Δy|, respectively referred to as MSB_{Δx} and MSB_{Δy}, and a fourth block 11, which calculates the minimum value between MSB_{Δx} and MSB_{Δy}, and the result of such a calculation is added to the value 1−N_{BIT} in an adder 13 for providing the parameter L.

The second sub-module 17 of the second module 16 comprises two shift registers Rₓ and R_{y}, where the values Δx and Δy are stored, and where it is performed a right shift operation consisting in right shifting by L positions said values Δx and Δy.

The outputs δₓ and δ_{y} of the two registers Rₓ and R_{y} are inputted to a function generator 19 together with the input parameters y_{A} and N. The output of the function generator 19 is the output function y(x).

With reference to FIG. 7, it is described in more detail the function generator 19, which comprises a digital counter 21, which counts modulo N, an accumulator 23 and a register R_{OUT}.

The output signal y(x) starts assuming the initial value y_{A}, which is loaded in the register Rₒᵤₜ at the beginning of the interpolation process. The output signal y(x) is kept constant for a group of δx consecutive points (hold step) and then is varied of δy (variation step). The increment is controlled by the enabling signal ENABLE provided by the counter 21. The generation of the function y(x) is then executed until N interpolated points are generated.

In order to better clarify the method of the invention two examples of application are hereinafter provided and represented in FIGS. 8 and 9, wherein the known points A and B are represented by squares and the interpolated points are represented by rhombuses. In the following the binary numbers are distinguished from decimal numbers by using the subscript 2, denoting the binary base.

### EXAMPLE 1

Input Data Of The Interpolation Algorithm
Number of interpolated values: N=11
First known point: A=(x_{A},y_{A})=(0, 10)
Second known point: B=(x_{B},y_{B})=(x_{A}N+1,y_{B})=(0+11+1,18)=(12, 18)
Minimum resolution of δₓ and δ_{y} in bits: N_{BIT}=2

First Step: Calculation of the Interval Lengths Δx and Δy

Δx=x_{B}−x_{A}=12−0=12 =1100₂

Δy=y_{B}−y_{A}=18−10=8=1000₂

Second Step: Calculation of L
MSB_{Δx}=3
MSB_{Δy}=3

L=min(MSB_{Δx},MSB_{Δy})+1−N_{BIT}=min(3,3)+1−2=2

Third Step: Calculation of δₓ and δ_{y}

δx=Δx>>L=1100₂>>2=11₂=3

δy=Δy>>L=1000₂>>2=10₂=2

Fourth Step: Generation of the Interpolation Function. The ordinate of the interpolated points is kept constant for a group of δx consecutive points (hold step) and then varied of δy (variation step). The process starts from the known point A and is repeated iteratively until N interpolated points between A and B are generated. In this case all the steps of the interpolation function have the same length and each step is composed of δₓ=3 points with the same ordinate. It can be noticed that in this example there is no approximation in the calculation of the angular coefficient of the straight line that joins the known points A and B, so that m=Δy/Δx=\tilde{m}=δy/δx=2/3. The generation of the interpolation function and the corresponding signal y(x) at the output of the interpolator device 1 is shown in FIG. 8.

### EXAMPLE 2

Input Data of the Interpolation Algorithm
Number of interpolated values: N=10
First known point: A=(x_{A},y_{A})=(0, 5)
Second known point: B=(x_{B},y_{B})=(x_{A}+N+1,y_{B})=(0+10+1,28)=(11, 28)
Minimum resolution of δₓ and δ_{y} in bits: N_{BIT}=2

First step: Calculation of the Interval Lengths Δx and Δy

Δx=x_{B}−x_{A}=11−0=11=1011₂

Δy=y_{B}−y_{A}=28−5=23=10111₂

Second step: Calculation of L
MSB_{Δx}=3
MSB_{Δy}=4

L=min(MSB_{Δx},MSB_{Δy})+1−N_{BIT}=min(3,4)+1−2=2

Third step: Calculation of δₓ and δ_{y}

δx=Δx>>L=1011₂>>2=10₂=2

δy=Δy>>L=10111₂>>2=101₂=5

Fourth Step: Generation of the Interpolation Function. The ordinate of the interpolated points is kept constant for a group of δx consecutive points (hold step) and then varied of δy (variational step). The process starts from the known point A and is repeated iteratively until N interpolated points between A and B are generated. In this example the last step of the interpolation function has a different length because it is composed of only one interpolated value, compared to the other steps that are composed of δₓ=2 points. It may be noticed that in this example the value of \tilde{m}=δy/δx=2.5 is an approximation in excess of the angular coefficient m=Δy/Δx=2.09 of the straight line that joins the know points A and B. This approximation reflects to the last interpolated point 18 that has an ordinate greater that the ordinate of the known point B. The generation of the interpolation function and the corresponding signal y(x) at the output of the interpolation device 1 is shown in FIG. 9.

It is clear from the above detailed examples that the logic operations to be performed for implementing the method according to the invention (right-shifting, additions, calculation of most significant bit and so on) are very easy and fast to calculate. Moreover, these operations may be well performed by logic circuits of minimal complexity. In addition, the method is so conceived that the number of interpolated points between two known points may be varied every time that the interpolation method must be performed. This feature is very important when using the method according to the invention for channel estimation in communication systems, as pilot patterns may flexibly vary according to the transmission scheme adopted and therefore also the number of interpolated points may vary accordingly.

Although the method and apparatus of the present invention has been illustrated and described with regard to presently preferred embodiments thereof, it will be understood that numerous modifications and substitutions may be made to the embodiments described, and that numerous other embodiments of the invention may be implemented without departing from the spirit and scope of the invention as defined in the following claims.

For instance, the method according to the invention may also be applied to sampled signals, wherein the independent values represent a discrete spatial, time or frequency index and said dependent variables represent values of a sampled signal. For instance, in a computer graphics application, the abscissa of the points to be interpolated may represent the pixel position on the screen, while the ordinate may represent the colour level quantized on a suitable number of bits.

1-18. (canceled)

19. A method for interpolating between a first and a second point, said first point comprising a first independent value and a first dependent value and said second point comprising a second independent value and a second dependent value, said independent and dependent values being representable with fixed point values, comprising the steps of:
calculating a first distance between said first and second independent values and a second distance between said first and second dependent values;
right shifting said first and said second distances by a predetermined number of bits for obtaining respectively a hold step and a variational step; and
generating a number of interpolated points, having independent values between said first and said second independent values and corresponding dependent values obtained by alternating hold and variational phases, wherein said hold phase consists of generating a number of points corresponding to said hold step maintaining a same dependent value, and wherein said variational phase consists of varying the dependent value by said variational step until said number of interpolated points has been calculated.

20. The method according to claim 19, wherein, when calculating the last of said number of interpolated points, the corresponding hold phase ends.

21. The method according to claim 19, wherein said number of interpolated points is a parameter selected by the user.

22. The method according to claim 21, wherein said number of interpolated points is equal to said first distance less one.

23. The method according to claim 19, wherein the dependent value of a first hold phase is equal to said first dependent value.

24. The method according to claim 19, wherein the dependent value of a first hold phase is equal to said first dependent value plus a constant value.

25. The method according to claim 19, wherein said number of bits depends on a resolution parameter representing the resolution according to which said hold and variational steps are represented.

26. The method according to claim 25, wherein said number of bits is equal to a value calculated as a minimum between a most significant bit position of said first distance and a most significant bit position of said second distance less said resolution parameter plus one, if said value is greater than or equal to zero, and said number of bits is set at zero if said value is negative.

27. The method according to claim 25, wherein said resolution parameter is an integer number between 2 and 4.

28. The method according to claim 19, wherein said independent values represent a discrete spatial, time or frequency index and said dependent variables represent values of a sampled signal.

29. A method of estimating a transmission channel in a communication system through a calculation by interpolation of a number of unknown channel coefficients between two known channel coefficients corresponding to transmitted pilot symbols, comprising computing said unknown channel coefficients by means of the method according to claim 19, wherein said dependent values are said channel coefficients and said independent values are discrete channel coefficient indexes in a time or frequency domain.

30. An interpolating device for interpolating between a first and a second point, said first point comprising a first independent value and a first dependent value and said second point comprising a second independent value and a second dependent value, said independent and dependent values being representable with fixed point values and available as input parameters to said device comprising:
a first module or calculating a second distance between said first and second dependent values;
a second module for right shifting a first distance and said second distances by a predetermined number of bits for obtaining respectively a hold step and a variational step, said first distance being a distance between said first and second independent values; and
a function generator for generating a number of interpolated points, having independent values between said first and said second independent values and corresponding dependent values obtained by alternating hold and variation phases, wherein said hold phase consists of generating a number of points corresponding to said hold step maintaining a same dependent value, and wherein said variational phase consists of varying the dependent value by said variational step until said number of interpolated points has been calculated.

31. The interpolating device according to claim 30, wherein said second module comprises a first sub-module for calculating said predetermined number of bits and a second sub-module for right shifting said first and second distances by said predetermined number of bits.

32. The interpolating device according to claim 30 wherein said first module comprises a first adder comprising a first input coupled to receive said first dependent value, a second input coupled to receive said second dependent value and an output providing a difference, and a first block for calculating the absolute value of said difference, said first block comprising an input coupled to the output of said first adder and an output providing said second distance.

33. The interpolating device according to claim 31, wherein said first sub-module of said second module comprises:
a second block comprising an input coupled to receive said first distance and an output providing the most significant bit position of said first distance;
a third block comprising an input coupled to the output of said first block and an output providing the most significant bit position of said second distance;
a fourth block comprising two inputs respectively coupled to the output of said second and third blocks and an output providing the minimum value between said two most significant bit positions; and
a second adder comprising a first input coupled to the output of said fourth block and a second input coupled to receive a value 1−N_{BIT}, wherein N_{BIT} is a resolution parameter, and an output providing a predetermined number of bits.

34. The interpolating device according to claim 33, wherein said second sub-module of said second module comprises:
a first shift register comprising a first input coupled to receive said first distance, a second input coupled to the output of said second adder and an output providing said first distance shifted by a number of positions corresponding to said shift number;
a second shift register comprising a first input coupled to the output of said first adder, a second input coupled to the output of said second adder and an output providing said second distance shifted by a number of positions corresponding to said predetermined number of bits.

35. The interpolating device according to claim 30 wherein said function generator comprises:
a digital counter comprising a first input coupled to the output of said first shift register, a second input coupled to receive said parameter representing the number of required interpolated points and an output providing an enable signal, said counter counting module; and
an accumulator comprising a first input coupled to the output of said second shift register, a second input coupled to the output of said digital counter and a third input coupled to the output of a register,
said register having a first input coupled to the output of said accumulator, a second input coupled to receive said first dependent value and an output which provides said linear interpolated value.

36. A communication receiver provided with a channel estimation unit for estimating a transmission channel in a communication system, wherein said channel estimation unit comprises an interpolating device according to claim 30.
